(19) United States
(12) Patent Application Publication
(10) Pub. No.: US 2024/0239417 A1
(43) Pub. Date: Jul. 18, 2024

(54) VEHICLE CHARGER ATTACHMENT STRUCTURE

(71) Applicant: TOYOTA JIDOSHA KABUSHIKI KAISHA, Toyota-shi (JP)

(72) Inventors: Masanori UCHIMURA, Miyoshi-shi (JP); Kohichi TANIOKA, Toyota-shi (JP)

(21) Appl. No.: 18/525,879

(22) Filed: Dec. 1, 2023

(30) Foreign Application Priority Data
Jan. 13, 2023 (JP) 2023-003973

(51) Int. Cl. B62D 25/20; B60L 53/16

(52) U.S. Cl. CPC B62D 25/2027; B60L 53/16

(57) ABSTRACT

A vehicle charger attachment structure includes: a rear floor panel provided at a vehicle rear part and having a concave part; a first bracket that is curved along a peripheral part of the concave part and fixed to the rear floor panel; and a second bracket that is formed with a hat-shaped cross section and fixed to a bottom part of the concave part, and that has a second attachment part to which a charger is attachable, wherein: one end part of the first bracket is disposed at a position that overlaps in plan view with a side member that is joined to the rear floor panel and extends in a vehicle front-rear direction, and another end part of the first bracket is disposed at a position that overlaps in plan view with a component joined to the rear floor panel.

### CROSS-REFERENCE TO RELATED APPLICATION

This application is based on and claims priority under 35 USC 119 from Japanese Patent Application No. 2023-003973, filed on Jan. 13, 2023, the disclosure of which is incorporated by reference herein.

### BACKGROUND

### Technical Field

The present disclosure relates to a vehicle charger attachment structure.

### Related Art

International Publication (WO) No. 2011/145380 discloses a structure in which a battery and a charger are mounted at a rear floor panel of a vehicle. The charger is accommodated in a recess formed in the rear floor panel, and the battery is disposed above the charger so as to straddle the recess.

In the structure of WO No. 2011/145380, since the charger is installed at the bottom of the recess formed in the rear floor panel, there is a possibility that the rigidity of the attachment portion of the charger cannot be sufficiently ensured.

### SUMMARY

The present disclosure aims to obtain a vehicle charger attachment structure that enables the rigidity of an attachment portion for a charger to be improved in a structure in which a charger is attached to a rear floor panel provided with a recess.

A vehicle charger attachment structure according to a first aspect includes: a rear floor panel provided at a vehicle rear part and having a concave part recessed toward a vehicle lower side; a first bracket that is curved along a peripheral part of the concave part in the rear floor panel and fixed to the rear floor panel, and that has a first attachment part to which a charger is attachable; and a second bracket that is formed with a hat-shaped cross section and fixed to a bottom part of the concave part, and that has a second attachment part to which a charger is attachable, in which: one end part of the first bracket is disposed at a position that overlaps in plan view with a side member that is joined to the rear floor panel and extends in a vehicle front-rear direction, and another end part of the first bracket is disposed at a position that overlaps in plan view with a component joined to the rear floor panel.

In the vehicle charger attachment structure according to the first aspect, the rear floor panel has a concave part recessed toward a lower side of the vehicle, and a first bracket is fixed to the rear floor panel. The first bracket is curved along a peripheral part of the concave part in the rear floor panel. Further, the first bracket includes a first attachment part to which a charger can be attached. Moreover, a second bracket having a hat-shaped cross section is fixed to the bottom of the concave part in the rear floor panel, and the second bracket includes a second attachment part to which the charger can be attached. This enables the charger to be attached to the first bracket and the second bracket via the first attachment part and the second attachment part.

Moreover, one end part of the first bracket is disposed at a position that overlaps in plan view with the side member, and the other end part is disposed at a position that overlaps in plan view with the a component joined to the rear floor panel. As a result, even in cases in which vibration or the like is input to the charger during travel on a bad road, since the fixed portions of the first bracket are reinforced by the side member and the component joined to the rear floor panel, deformation of the attachment portions of the charger can be suppressed.

A vehicle charger attachment structure according to a second aspect is the first aspect, in which the first bracket is provided with a convex bead that is continuous from the one end part to the other end part.

In the vehicle charger attachment structure according to the second aspect, the rigidity of the first bracket can be improved by the convex bead that continues from one end to the other end of the first bracket.

A vehicle charger attachment structure according to a third aspect is the first aspect, in which the second bracket comprises a pair of side wall parts, and an upper wall part connecting respective upper end parts of the side wall parts, the second attachment part is provided at the upper wall part, and each of the pair of side wall parts is corrugated.

In the vehicle charger attachment structure according to the third aspect, since the side wall parts of the second bracket are formed in a corrugated shape, compared to a configuration in which the side wall parts are planar, the rigidity of the second bracket can be improved.

A vehicle charger attachment structure according to a fourth aspect is the first aspect, in which the other end part of the first bracket is disposed at a position that overlaps in plan view with a canister attachment part.

In the vehicle charger attachment structure according to the fourth aspect, the attachment part of the first bracket is reinforced by utilizing an attachment part of a canister attached to the rear floor panel. This eliminates the need to provide a dedicated reinforcement member or the like.

A vehicle charger attachment structure according to a fifth aspect of the present is any one of the first to fourth aspects, in which the first bracket extends in a vehicle width direction and the second bracket extends in the vehicle front-rear direction.

In the vehicle charger attachment structure according to the fifth aspect, the extension directions of the first bracket and the second bracket intersect each other. As a result, even in cases in which loads in either the vehicle front-rear direction or the vehicle width direction are input to the attachment portions of the charger, the attachment state of the charger can be favorably maintained.

According to the vehicle charger attachment structure according to the present disclosure, the rigidity of the attachment portions of a charger can be improved in a structure in which the charger is attached to a rear floor panel provided with a concave part.

### BRIEF DESCRIPTION OF THE DRAWINGS

An exemplary embodiment of the present disclosure will be described in detail based on the following figures, wherein:

FIG. 1 is a plan view illustrating a rear part of a vehicle to which a vehicle charger attachment structure according to an exemplary embodiment has been applied, and is a diagram illustrating positional relationships between a charger and brackets;

FIG. 2 is a plan view illustrating a rear part of a vehicle to which a vehicle charger attachment structure according to an exemplary embodiment has been applied, and is a diagram illustrating positional relationships between a side member and brackets; and

FIG. 3 is a perspective view of a second bracket.

### DETAILED DESCRIPTION

Explanation follows regarding a vehicle charger attachment structure according to an exemplary embodiment, with reference to the drawings. Note that the arrow RR and arrow RH in the drawings respectively indicate a rear side in a vehicle front-rear direction, and a right side of the vehicle facing a travel direction, in a vehicle V to which a vehicle charger attachment structure is applied, as appropriate. In the following, in the case of explanation using only forward/rearward, upward/downward, and left/right directions, unless otherwise specified, these indicate forward and rearward in a vehicle front-rear direction, upward and downward in a vehicle vertical direction, and left and right in a vehicle width direction.

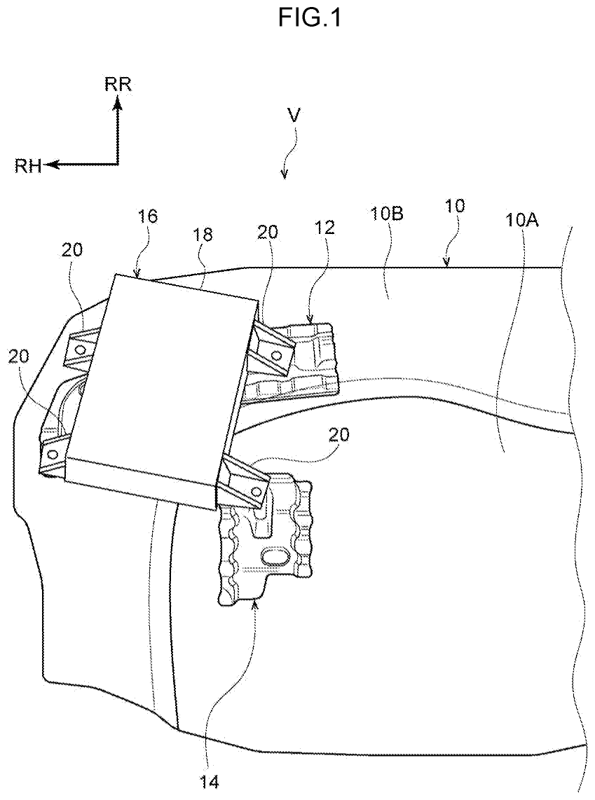

As illustrated in FIG. 1, a rear floor panel 10 is provided at a rear part of a vehicle V to which a vehicle charger attachment structure is applied. The rear floor panel 10 extends in a vehicle front-rear direction and a vehicle width direction with a vertical direction serving as a plate thickness direction, and configures a floor surface of a baggage compartment. Note that as an example, the vehicle V of the present exemplary embodiment is a PHEV (Plug-in Hybrid Electric Vehicle) including an engine and a motor as a drive source, but the embodiment may be applied to a BEV (Battery Electric Vehicle) that does not include an engine and uses only a motor as a drive source.

A concave part 10A is formed in the rear floor panel 10. The concave part 10A is recessed toward a vehicle lower side with respect to a peripheral part 10B of the rear floor panel 10, and a step is formed between the concave part 10A and the peripheral part 10B.

Note that a first bracket 12 is fixed to the peripheral part 10B of the rear floor panel 10, and a second bracket 14 is fixed to the concave part 10A of the rear floor panel 10. A charger 16 is attached to the first bracket 12 and to the second bracket 14.

Note that in the present exemplary embodiment, as an example, the rear floor panel 10 is a common component in PHEV specifications and in hybrid electric vehicle (HEV) specifications that do not include a charging port. Moreover, in HEV specifications, since a charger, described below, is not required, a spare tire or the like is accommodated in the concave part 10A. In PHEV specifications, a second bracket 14 for attaching a charger 16 is fixed to the concave part 10A instead of a spare tire.

The charger 16 is a device for charging a non-illustrated battery installed in the vehicle V, and is configured so as to be connected with a charging cable during charging. The charger 16 and the battery are connected by a non-illustrated cable, enabling power to be supplied from the charger 16 to the battery.

The charger 16 is configured including a substantially rectangular parallelepiped-shaped main body part 18 and plural leg parts 20 provided at the main body part 18. In the present exemplary embodiment, as an example, the leg parts 20 are respectively provided at the four corners of the main body part 18.

Two leg parts 20 are provided at front and rear at a side surface at the vehicle right side of the main body part 18, and the front leg part 20 is disposed on the first bracket 12. The rear leg part 20 is disposed on the rear floor panel 10.

On a side surface at the vehicle left side of the main body part 18, two leg parts 20 are provided at front and rear, and the front leg part 20 is disposed on the second bracket 14. The rear leg part 20 is disposed on the first bracket 12. The four leg parts 20 are each provided with attachment holes, and fasteners such as bolts are inserted through these attachment holes so that the leg parts 20 are respectively attached to the first bracket 12, the second bracket 14, and the rear floor panel 10.

### (First Bracket 12)

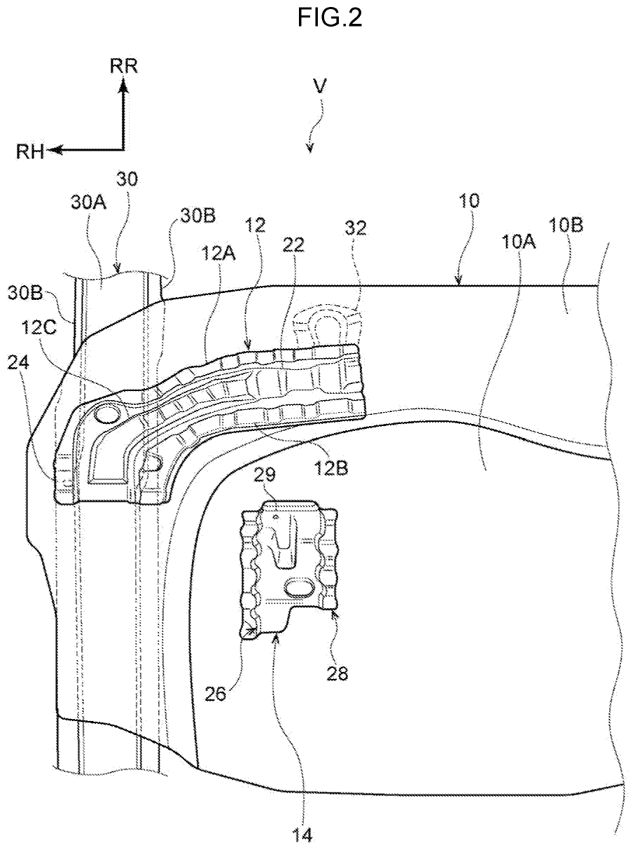

As illustrated in FIG. 2, the first bracket 12 is formed of a sheet metal that is curved along the peripheral part 10B of the rear floor panel 10, and extends overall in the vehicle width direction. Moreover, an end part (one end part) of the first bracket 12 on the right side of the vehicle extends toward the vehicle front along the peripheral part 10B of the rear floor panel 10.

Note that the first bracket 12 includes a first convex bead 12A, a second convex bead 12B, and a third convex bead 12C. The first convex bead 12A is continuously formed from an end part on the right side of the vehicle to an end part (other end part) on the left side of the vehicle along an outer edge of a vehicle rearward side of the first bracket 12. The first convex bead 12A is formed in a concavo-convex shape along the extension direction, and a concave part of the first convex bead 12A is joined to the rear floor panel 10 by spot welding or the like. Moreover, a vehicle left side end part of the first convex bead 12A configures a first attachment part 24 to which the leg part 20 of the battery charger 16 can be attached.

The second convex bead 12B is continuously formed from an end part on the right side of the vehicle to an end part on the left side of the vehicle along an outer edge of a vehicle forward side of the first bracket 12. Similarly to the first convex bead 12A, the second convex bead 12B is formed in a concavo-convex shape along the extension direction. The concave part of the second convex bead 12B is joined to the rear floor panel 10 by spot welding or the like.

The third convex bead 12C is formed between the first convex bead 12A and the second convex bead 12B of the first bracket 12, and is continuously formed from an end part at a right side of the vehicle to an end part at a left side of the vehicle along the center in a width direction of the first bracket 12. A vehicle left side end part of the third convex bead 12C is a first attachment part 22 to which the leg part 20 of the battery charger 16 can be attached.

Note that an end part of the first bracket 12 on the vehicle right side is disposed at a position overlapping with a side member 30 in plan view. More specifically, a side member 30 extending in the vehicle front-rear direction is provided at a lower surface side of the rear floor panel 10. The side member 30 is provided as a left and right pair, and only the side member 30 on the vehicle right side is illustrated in FIG. 2.

The side member 30 includes a lower wall part 30A and a pair of left and right side wall parts 30B, and the lower wall part 30A extends in the vehicle front-rear direction at a lower side than the rear floor panel 10. The lower wall part 30A extends upward from both left and right ends of the lower wall part 30A, and an upper end part of the lower wall part 30A is a flange part bent along the rear floor panel 10. These flange parts are joined to the bottom surface of the rear floor panel 10, and part of the flange part overlaps with the first convex bead 12A and the second convex bead 12B of the first bracket 12 in plan view.

Moreover, the vehicle left side end part of the first bracket 12 is disposed at a position that overlaps in plan view with an attachment part of a canister joined to the rear floor panel 10. More specifically, an attachment bracket 32 is provided at a lower surface side of the rear floor panel 10, inward of the side member 30 in the vehicle width direction.

The attachment bracket 32 is joined to the rear floor panel 10, and a non-illustrated canister is fixed to the attachment bracket 32. Moreover, a front part of the attachment bracket 32 overlaps in plan view with an end part of the first bracket 12 at the vehicle left side.

### (Second Bracket 14)

A second bracket 14 is provided at a vehicle forward side of the first bracket 12. The second bracket 14 is fixed to a bottom part of the concave part 10A of the rear floor panel 10, and extends in the vehicle front-rear direction. Moreover, the second bracket 14 is formed in a substantial hat shape in cross section, with a vehicle upper side being convex as viewed from the vehicle front-rear direction.

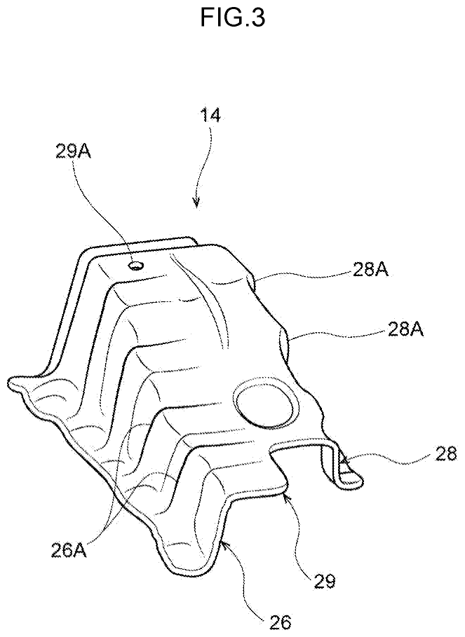

As illustrated in FIG. 3, the second bracket 14 is configured including a side wall part 26, a side wall part 28, and an upper wall part 29. The side wall part 26 faces the right side of the vehicle in a state in which the side wall part 26 is fixed to the rear floor panel 10, and extends in the vehicle vertical direction and the vehicle front-rear direction.

The side wall part 26 is formed in a corrugated shape. More specifically, the side wall part 26 is formed with plural convex beads 26A extending vertically. The respective convex beads 26A project outward from a general part of the side wall part 26 of the second bracket 14. The convex bead 26A is plurally formed at intervals in the vehicle front-rear direction. As described above, the side wall part 26 is formed in a corrugated shape by the plural convex beads 26A.

The side wall part 28 faces the left side of the vehicle in a state in which the side wall part 28 is fixed to the rear floor panel 10, and extends in the vehicle vertical direction and the vehicle front-rear direction. Moreover, the side wall part 28 is formed to be shorter than the side wall part 26 in the vehicle front-rear direction, and plural convex beads 28A are formed in the side wall part 28.

The convex beads 28A extend vertically, and are plurally formed at intervals in the vehicle front-rear direction. Since the respective convex beads 28A project outward from the general part of the side wall part 28, the side wall part 28 is formed in a corrugated shape by the convex beads 28A.

The upper wall part 29 connects together the upper ends of the side wall part 26 and the side wall part 28, and extends in the vehicle width direction and in the vehicle front-rear direction. An attachment hole 29A serving as a second attachment part is formed at a rear end part of the upper wall part 29, and a leg part 20 of the charger 16 is attached to the attachment hole 29A. In addition, a non-illustrated waste heat bracket is attached to a front end part of the upper wall part 29.

As illustrated in FIG. 2, the height of the upper wall part 29 of the second bracket 14 is approximately the same as the height of the first bracket 12. Accordingly, even in cases in which the concave part 10A is provided in the rear floor panel 10, the configuration is such that the charger 16 can be attached to the first bracket 12 and the second bracket 14.

### (Mechanism)

Next, explanation follows regarding the mechanism of the present exemplary embodiment.

According to the vehicle charger attachment structure of the present exemplary embodiment, the rear floor panel 10 has a concave part 10A recessed toward the lower side of the vehicle, and a first bracket 12 is fixed to the rear floor panel 10. The first bracket 12 is curved along the peripheral part 10B of the concave part 10A of the rear floor panel 10. Moreover, the first bracket 12 includes a first attachment part 22 and a first attachment part 24 to which the charger 16 is attachable.

Moreover, a second bracket 14 having a hat-shaped cross section is fixed to a bottom part of the concave part 10A of the rear floor panel 10, and the second bracket 14 is provided with an attachment hole 29A at which the charger 16 can be attached. This enables the charger 16 to be attached to the first bracket 12 and the second bracket 14 via the first attachment part 22, the first attachment part 24, and the attachment hole 29A.

Moreover, one end of the first bracket 12 is disposed at a position that overlaps with the side member 30 in a plan view, and the other end of the first bracket 12 is disposed at a position that overlaps with the attachment bracket 32 of the canister in plan view. As a result, even in cases in which vibration or the like is input to the charger 16 during travel on a bad road, since the fixing portion of the first bracket 12 is reinforced by the side member 30 and the attachment bracket 32 joined to the rear floor panel 10, deformation of the attachment portion of the charger 16 can be suppressed.

Moreover, in the present exemplary embodiment, the rigidity of the first bracket 12 can be improved by the first convex bead 12A, the second convex bead 12B, and the third convex bead 12C, which are continuous from one end to the other end of the first bracket 12.

Moreover, in the present exemplary embodiment, since the side wall part 26 and the side wall part 28 of the second bracket 14 are formed in a corrugated shape, compared to a configuration in which the side wall part 26 and the side wall part 28 are planar, the rigidity of the second bracket 14 can be improved.

Moreover, in the present exemplary embodiment, the attachment portion of the first bracket 12 is reinforced using the attachment bracket 32 of the canister attached to the rear floor panel 10. This eliminates the need to provide a dedicated reinforcement member or the like.

Moreover, in the present exemplary embodiment, the extension directions of the first bracket 12 and the second bracket 14 intersect each other. As a result, even in cases in which loads in either the vehicle front-rear direction or the vehicle width direction are input to the attachment portion of the charger 16, the attached state of the charger 16 can be favorably maintained.

In particular, since a stepped part of the rear floor panel 10 is provided between the first bracket 12 and the second bracket 14, compared to a configuration in which there is no stepped part, the rigidity of the attachment portion of the charger 16 can be improved. As described above, in the structure in which the charger 16 is attached to the rear floor panel 10 in which the concave part 10A is formed, the rigidity of the attachment portion of the charger 16 can be improved.

Although explanation has been given regarding a vehicle charger attachment structure according to an exemplary embodiment, various embodiments may, of course, be implemented within a range not departing from the gist of the present disclosure. For example, although explanation has been given regarding a structure in which the charger 16 is attached to the vehicle right side end part in the rear floor panel 10 in the above exemplary embodiment, there is no limitation thereto, and the charger 16 may be attached to another portion.

Further, although the other end of the first bracket 12 is disposed at a position that overlaps with the attachment bracket 32 of the canister in plan view in the above exemplary embodiment, there is no limitation thereto, and it may be disposed at a position overlapping with another component in plan view.

Moreover, although in the above exemplary embodiments, the convex bead 26A is formed on the side wall part 26, and the convex bead 28A is formed on the side wall part 28, of the second bracket 14, there is no limitation thereto. For example, the side wall part 26 and the side wall part 28 may be formed in a corrugated shape as a whole.

What is claimed is:

1. A vehicle charger attachment structure, comprising:
a rear floor panel provided at a vehicle rear part and having a concave part recessed toward a vehicle lower side;
a first bracket that is curved along a peripheral part of the concave part in the rear floor panel and fixed to the rear floor panel, and that has a first attachment part to which a charger is attachable; and
a second bracket that is formed with a hat-shaped cross section and fixed to a bottom part of the concave part, and that has a second attachment part to which a charger is attachable, wherein:
one end part of the first bracket is disposed at a position that overlaps in plan view with a side member that is joined to the rear floor panel and extends in a vehicle front-rear direction, and
another end part of the first bracket is disposed at a position that overlaps in plan view with a component joined to the rear floor panel.

2. The vehicle charger attachment structure of claim 1, wherein the first bracket is provided with a convex bead that is continuous from the one end part to the other end part.

3. The vehicle charger attachment structure of claim 1, wherein:
the second bracket comprises a pair of side wall parts, and an upper wall part connecting respective upper end parts of the side wall parts,
the second attachment part is provided at the upper wall part, and
each of the pair of side wall parts is corrugated.

4. The vehicle charger attachment structure of claim 1, wherein the other end part of the first bracket is disposed at a position that overlaps in plan view with a canister attachment part.

5. The vehicle charger attachment structure of claim 1, wherein the first bracket extends in a vehicle width direction and the second bracket extends in the vehicle front-rear direction.
